(19) United States
(12) Patent Application Publication
(10) Pub. No.: US 2007/0041365 A1
(43) Pub. Date: Feb. 22, 2007

(54) EBay and Google VoIP telephone

(75) Inventor: Allen Nejah, San Jose, CA (US)

Correspondence Address: PATENT LAW GROUP LLP, 2635 NORTH FIRST STREET, SUITE 223, SAN JOSE, CA, 95134, US

(73) Assignee: SunMan Engineering, Inc.

(21) Appl. No.: 11/298,112

(22) Filed: Dec. 8, 2005

Related U.S. Application Data
(63) Continuation-in-part of application No. 11/200,564, filed on Aug. 9, 2005.

(51) Int. Cl. H04L 12/66

(52) U.S. Cl. 370/352

(57) ABSTRACT

A network telephone device allows the user to make VoIP telephone calls and to access eBay or Google. The device includes a corded or cordless handset, a telephony processor for making the VoIP telephone calls and for accessing eBay or Google, a dial-up modem for making a narrowband connection to the Internet, and an input device (e.g., a touch screen, a keypad, or a microphone) for interacting with eBay or Google. To use eBay or Google, the telephony processor uses a mini-browser to access a simplified website of eBay or Google, and the user uses the input device to navigate through the pages of the website.

### CROSS REFERENCE TO RELATED APPLICATION

This application is a continuation-in-part of commonly assigned U.S. patent application Ser. No. 11/200,564, attorney docket no. SME-P103, filed on Aug. 9, 2005, entitled “Voice-over-IP Telephone Devices and Systems,” which is incorporated herein by reference.

This application is related to commonly assigned U.S. patent application Ser. No. 11/077,261, attorney docket no. SME-P102, filed on Mar. 9, 2005, entitled “Voice-over-IP Device Using Dial-Up Modem,” which is incorporated herein by reference.

### FIELD OF INVENTION

This invention relates to VoIP (Voice over Internet Protocol) telephone devices and services.

### DESCRIPTION OF RELATED ART

There are many VoIP service providers, such as AT&T, Vonage, Lingo, BroadVoice, and Packet8. FIG. 1 illustrates a typical setup 100 available from these service providers. An analog telephone adapter (ATA) 102 is provided to the customer. ATA 102 has an RJ-11 phone port connected to an analog telephone 104. ATA 102 also has an RJ-45 network port connected to a router 106 of a private computer network 107. Router 106 has RJ-45 network ports connected to a personal computer 108 and a broadband modem 120 (e.g., a cable or a DSL modem) in private compute network 107. Broadband modem 120 is coupled through a public computer network 122 (e.g., the Internet) to a network telephone service provider 124.

VoIP uses packet switching to open a connection to send the data necessary for the telephone conversation. VoIP allows several telephone calls to occupy the amount of space occupied by only one in a circuit-switched network.

### BRIEF DESCRIPTION OF THE DRAWINGS

FIG. 1 illustrates a prior art network telephone system.

FIG. 2 illustrates a network telephone system in one embodiment of the present invention.

FIG. 3 illustrates a network telephone device in the system of FIG. 2 in one embodiment of the invention.

FIG. 4 illustrates a telephony processor in the network telephone device of FIG. 3 in one embodiment of the invention.

FIG. 5 illustrates the appearance of a network telephone device of FIG. 3 in one embodiment of the invention.

FIGS. 6 and 7 illustrate screens displayed by the telephone device of FIG. 5 to access an online auction service in one embodiment of the invention.

FIG. 8 illustrates a screen displayed by the telephone device of FIG. 5 to access an online search engine in one embodiment of the invention.

FIG. 9 illustrates a network telephone system in one embodiment of the present invention.

FIG. 10 illustrates a network telephone device in the system of FIG. 9 in one embodiment of the invention.

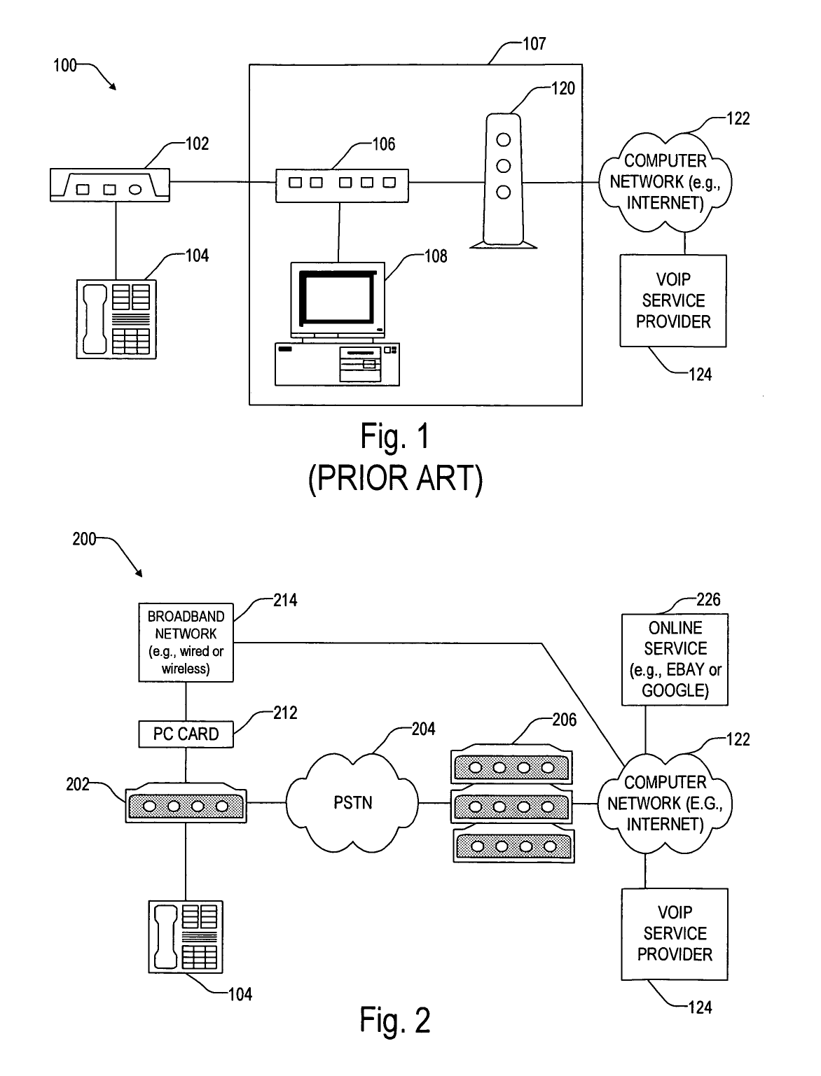

Use of the same reference numbers in different figures indicates similar or identical elements.

### SUMMARY

In one embodiment, a network telephone device allows the user to make VoIP telephone calls and to access eBay or Google using a narrowband or a broadband connection to the Internet. The device includes a corded or cordless handset, a telephony processor for making the VoIP telephone calls and for accessing eBay or Google, a dial-up modem for making a narrowband connection to the Internet, and an input device (e.g., a touch screen, a keypad, or a microphone) for interacting with eBay or Google. To use eBay or Google, the telephony processor uses a mini-browser to access a simplified website of eBay or Google, and the user uses the input device to navigate through the pages of the website.

### DETAILED DESCRIPTION

VoIP (Voice-over-Internet Protocol) service providers require their customers to have broadband Internet access. However, many consumers do not have computers and broadband Internet access. In addition, major telecommunication carriers have underutilized modem banks left over from the early days of the Internet where dial-up was the dominant way of accessing the Internet. Furthermore, many traditional telephone users are not comfortable with computers and therefore do not take advantage of various services offered through the Internet, such as eBay and Google. Thus, a network telephone device is provided that operates like a traditional telephone while offering (1) VoIP over narrowband or broadband connection to the Internet and (2) access to online services such as eBay and Google.

FIG. 2 illustrates a network telephone device 202 in a network telephone system 200 in one embodiment of the invention. Device 202 has a phone port connected to analog telephone 104 and another phone port connected to a public switching telephone network (PSTN) 204. Analog telephone 104 may be a corded or cordless telephone. Device 202 allows the user to use a narrowband dial-up connection to make VoIP telephone calls and access online services.

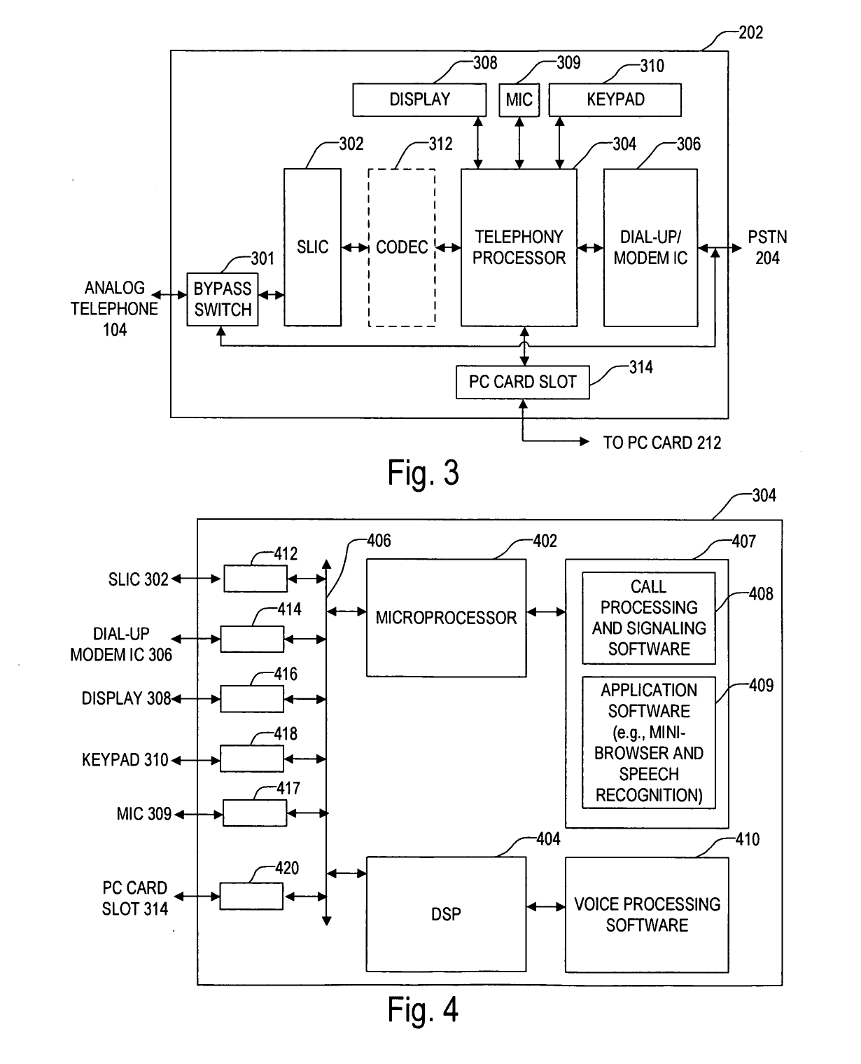

Device 202 uses an internal dial-up modem 306 (FIG. 3) to connect to a modem bank 206. Modem bank 206 then connects device 202 to VoIP service provider 124 and online service 226 over public computer network 122. Here, dial-up modem 306 acts as the network interface to public computer network 122. The connection between modem bank 206 and VoIP service provider 124 may be direct if they are a single entity or situated at the same location.

To initiate a call, the user dials telephone 104 like a traditional telephone. Device 202 takes the telephone number and sets up the telephone call through the narrowband dial-up connection to VoIP service provider 124. For the outgoing voice stream, device 202 compresses the voice stream, converts the voice stream into data packets, and sends the data packets by the narrowband dial-up connection to modem bank 206. Modem bank 206 then sends the data packets over public computer network 122 to VoIP service provider 124 or directly to the other party on the telephone call. For the incoming voice stream, device 202 receives the data packets through the narrowband dial-up connection, converts the data packets to compressed voice data, and reverts the compressed voice data to the incoming voice stream.

When a call is received, device 202 first determines if the incoming call is a plain old telephone service (POTS) call or a VoIP call. If the incoming call is a POTS call, device 202 routes the call to analog telephone 104. If the incoming call is a VoIP call through a narrowband dial-up connection, device 202 handles the incoming and the outgoing voice streams as described above. If device 202 supports multiple VoIP lines, device 202 also routes the incoming VoIP call to the appropriate phone port.

To access online service 226, the user instructs device 202 to connect with online service 226 (e.g., by pressing a button). In one embodiment, device 202 is an eBay telephone and online service 226 is eBay. In another embodiment, device 202 is a Google telephone and online service 226 is Google. Device 202 makes a connection with online service 226 through the narrowband dial-up connection with modem bank 206 and over public computer network 122. Device 202 then displays an interface with online service 226. The interface is designed so that the user can easily navigate through various menus to use online service 226. In one embodiment, device 202 has a mini-browser and the interface is a simplified website such as those provided in wireless web for mobile phones and personal data assistants using Wireless Application Protocol (WAP) web pages.

In one embodiment, device 202 has a PC card slot that accepts a PC card for added functionalities. If the user later decides to get broadband service, the user can add a PC card 212 to communicate with a computer network 214 with broadband access to public computer network 122 (e.g., the Internet). PC card 212 may be a wireless PC card and computer network may be a wireless network (e.g., a Wi-Fi or a WiMAX network) with broadband access. PC card 212 may be a network adapter PC card and computer network 214 may be a wired network (e.g., an Ethernet network) with broadband access. Thus, device 202 can also use a broadband connection to public computer network 122 for VoIP telephony and accessing online service 226. Here, PC card 212 acts as the network interface to public computer network 122.

FIG. 3 illustrates a network telephone device 202 in one embodiment of the invention. Device 202 includes a bypass switch 301, a subscriber line/loop interface circuit (SLIC) 302 coupled to bypass switch 301, a telephony processor 304 coupled to SLIC 302, and a dial-up modem 306 coupled to telephony processor 304. Bypass switch 301 has a first port (e.g., a standard telephone port) for connecting to analog telephone 104, a second port for connecting to SLIC 302, and a third port for connecting to PSTN 204. Bypass switch 301 operates to couple analog telephone 104 to either SLIC 302 or PSTN 204. When bypass switch 301 couples analog telephone 104 to SLIC 302, device 202 operates normally in either (1) a digital telephone mode to provide VoIP calls or (2) an analog telephone mode to provide POTS calls. Bypass switch 301 couples analog telephone 104 to PSTN 204 during power failures.

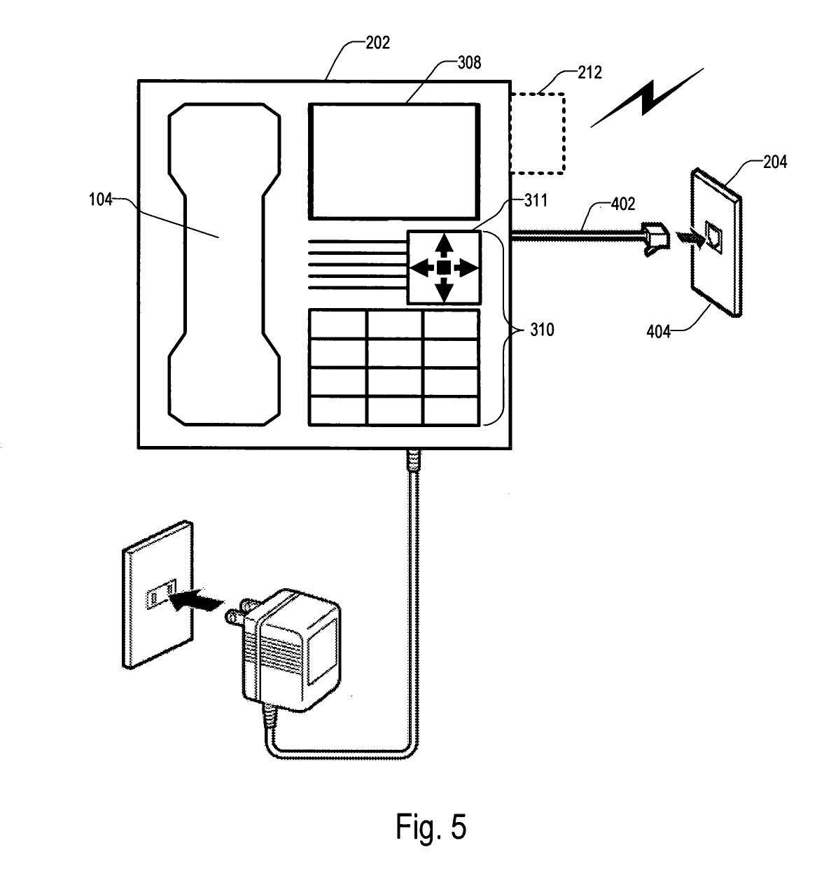

Dial-up modem 306 further has a port for connecting to PSTN 204. Note that dial-up modem 306 and bypass switch 301 share a common connection to PSTN 204. Telephony processor 304 has a port for connecting to a PC card slot 314 for receiving PC card 212, and ports for connecting to a display 308 (e.g., a screen or a touch screen), a microphone 309, a keypad 310 with a joystick 311 (FIG. 5), and other I/O devices (e.g., a USB keyboard). The user may use touch screen 308, microphone 309, keypad 310, and other I/O devices to control device 202 and navigate through the menus for online service 226. For example, the user can use touch screen 308 and joystick 311 to provide physical inputs to device 202, and the user can use microphone 309 to provide speech commands to device 202.

SLIC 302 converts 2-wire analog telephone signals from analog telephone 104 to outgoing 4-wire analog telephone signals destined for telephony processor 304. Vice versa, SLIC 302 converts incoming 4-wire analog telephone signals to the 2-wire analog telephone signals destined for analog telephone 104. SLIC 302 also provides other functions including battery feed, off-hook detection, and ringing for analog telephone 104. In one embodiment, SLIC 302 is an AG1170 from Silver Telecom of West Wales, United Kingdom.

In one embodiment, a coder-decoder (CODEC) 312 is coupled between SLIC 302 and telephony processor 304 to converts the outgoing 4-wire analog telephone signals from SLIC 302 to an outgoing digital audio stream destined for telephony processor 304. Vice versa, CODEC 312 converts an incoming digital audio stream from telephony processor 304 into the incoming 4-wire analog telephone signals. Alternatively, CODEC 312 is incorporated into telephony processor 304.

Telephony processor 304 converts the outgoing telephone signals from SLIC 302 into outgoing data packets. Depending if a narrowband dial-up connection or a broadband connection is used, telephony processor 304 sends the outgoing data packets to dial-up modem 306 or PC card 212. Vice versa, telephony processor 304 converts incoming data packets from dial-up modem 306 or PC card 212 into the incoming telephone signals destined for SLIC 302. Telephony processor 304 also performs voice compression, and calling processing and signaling according to the protocol accepted by VoIP service provider 124. In one embodiment, telephony processor 304 is a TNETV1050/1055 from Texas Instrument of Dallas, Tex.

When a narrowband dial-up connection is used, dial-up modem 306 converts the outgoing data packets into outgoing modem signals destined for modem bank 206. Vice versa, dial-up modem 306 converts incoming modem signals from modem bank 206 into the incoming data packets destined for telephony processor 304. Typically, dial-up modem 306 communicates at a speed of 56 kilobits per second (kbps). In one embodiment, dial-up modem 306 is a CX86500 from Conexant of Newport Beach, Calif.

When a broadband connection is used, PC card 212 routes the outgoing data packets through computer network 214 to public computer network 122. Vice versa, PC card 212 receives incoming data packets from computer network 214 destined for telephony processor 304.

FIG. 4 illustrates telephony processor 304 in one embodiment of the invention. Processor 304 includes a microprocessor 402 and a digital signal processor (DSP) 404 connected by a system bus 406. Microprocessor 402 is connected to a memory 407 that stores call processing and signaling software 408 and application software 409. Call processing and signaling software 408 handles standard VoIP protocols, such as H.323, H.323, and SIP.

In one embodiment, application 409 is a mini-browser used to interact with a simplified website of online service 226. In the embodiment where device 202 is an eBay telephone, application software 409 provides access to eBay. In the embodiment where device 202 is a Google telephone, application software 409 provides access to Google.

In one embodiment, application software 409 includes speech recognition software. The speech recognition software allows device 202 to receiving speech commands from the user through microphone 309. The user can navigate the simplified website of online service 226 by using speech commands. For example, the user can select one of the menu options on a webpage by speaking the name of the menu option, and the user can input text by speaking out letters, numbers, and words. The user can also use speech commands for dialing a telephone call. For example, the user can speak the number he or she wishes to dial. In addition, the speech recognition software may be programmed to recognize different users through their voices and automatically bring up an address book associated with a particular user.

Depending on the embodiment, application software 409 may further include other applications described in parent U.S. patent application Ser. No. 11/200,564.

DSP 404 is connected to a memory 410 that stores voice processing software. The voice processing software handles voice compression using a standard CODEC such as G.729a. System bus 406 is connected to a serial interface 412 for SLIC 302, a serial interface 414 for dial-up modem 306, a controller 416 for touch screen 308, a microphone interface 417 for microphone 309, a keypad interface 418 for keypad 310, and a PC card slot interface 420 for PC card slot 314.

FIG. 5 illustrates network telephone device 202 in one embodiment of the invention. In this embodiment, analog telephone 104 is integrated into device 202 so that device 202 looks like a traditional telephone. Although shown with a corded handset, device 202 may have a cordless handset. Furthermore, device 202 includes a PC card slot that accepts PC card 212 to access another network with broadband access to computer network 124 (e.g., the Internet). After purchase, a user simply plugs a telephone cord 402 to a wall jack 404 to access PSTN 204. Device 202 then operates either like a traditional telephone to make POTS calls or like a VoIP telephone to make VoIP calls. Additionally, device 202 provides access to online service 226.

In one embodiment, the user can manually set network telephone device 202 in an analog mode to make a POTS call (e.g., by pressing a button). In response, analog telephone signals between analog telephone 104 and PSTN 204 are routed through SLIC 302, CODEC 312, telephony processor 304, and dial-up modem 306 for a traditional POTS call without any processing. In another embodiment, telephony processor 304 automatically sets device 202 in the analog mode when it intercepts a dialed telephone number inside the toll-free calling area of the user or a dialed telephone number for emergency services (e.g., a 911 call). Telephony processor 304 then instructs dial-up modem 306 to dial the telephone number before routing the analog telephone signals between analog telephone 104 and PSTN 204.

In one embodiment, the user can manually set network telephone device 202 in a digital mode to make a VoIP call (e.g., by pressing a button). In another embodiment, telephony processor 304 automatically sets device 202 in the digital mode when it intercepts a dialed telephone number outside of the toll-free calling area of the user.

For a narrowband dial-up connection, telephony processor 304 instructs dial-up modem 306 to connect to modem bank 206. Once connected to modem bank 206, telephony processor 304 accesses VoIP service provider 124 to set up the VoIP telephone call according to the predetermined VoIP protocol. Once the two ends of the VoIP telephone call have been established, telephony processor 304 starts transmitting and receiving the VoIP data packets to the other end.

As described above, SLIC 302 converts outgoing analog telephone signals from analog telephone 104 into outgoing telephone signals destined for telephony processor 304. Telephony processor 304 compresses the digital telephone signals and then converts the compressed voice data into outgoing data packets destined for dial-up modem 306. Dial-up modem 306 converts the outgoing data packets into outgoing modem signals destined for modem bank 206. Dial-up modem 306 then sends the outgoing modem signals over PSTN 204 to modem bank 206, which then reverts the outgoing modem signals back to the outgoing data packets. Depending on the VoIP protocol, modem bank 206 routes the outgoing data packets to VoIP service provider 124 or directly to the other party on the VoIP telephone call over public computer network 122.

Dial-up modem 306 also converts incoming modem signals from modem bank 206 into incoming data packets destined for telephony processor 304. Telephony processor 304 converts the incoming data packets into compressed data and then reverts the compressed voice data back to incoming telephone signals destined for SLIC 302. SLIC 302 then converts the incoming telephone signals to incoming analog telephone signals destined for analog telephone 104.

To receive a call, dial-up modem 306 intercepts the incoming call and determines if it is a POTS call or a VoIP call from modem bank 206. If the call is a POTS call, telephony processor 304 routes the analog telephone signals between PSTN 204 and analog telephone 104. If the call is a VoIP call through a narrowband dial-up connection, telephony processor 304 handles the call setup and then processes the incoming and outgoing streams as described above.

Along with voice streams, device 202 can also simultaneously transmit and receive data streams. This is because the voice streams will only consume part of the bandwidth of dial-up modem 306. In one embodiment, the voice streams consume 8 to 12 kbps so the remainder of the bandwidth is available for data streams. Thus, even when the user is on a telephone call, the user can use application software 409 in device 202 to access online service 226 and other data services. The user can view online service 226 and other data on touch screen 308. The user can interact with optional application software 409 using touch screen 308, microphone 309, and keypad 310.

If the user later decides to get broadband service, the user can add PC card 212 to device 202. Instead of using the narrowband dial-up connection, telephony processor 304 can then use a broadband wireless or wired connection to make and receive VoIP calls and to accessing online service 226 as described above.

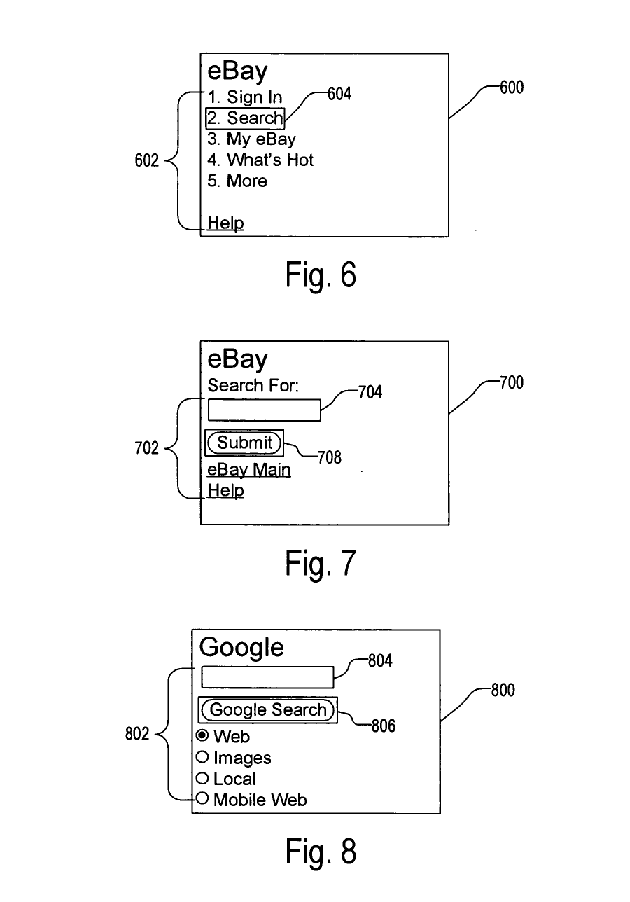

FIGS. 6 and 7 illustrate screens on touch screen 308 of device 202 while accessing online service 226 that is an online auction service (e.g., eBay) in one embodiment. In one embodiment, application software 409 is a mini-browser that displays a simplified website of online service 226.

FIG. 6 illustrates a splash page 600 shown to the user when device 202 initially connects with online service 226. Splash page 600 lists menu items 602. The user uses touch screen 308 to select one of the menu items. The user can also use joystick 311 in keypad 310 to move a highlighted cursor 604 and to select one of the menu items. Furthermore, the user can use speech commands to microphone 309 to select one of the menu items.

FIG. 7 illustrates a subsequent page 700 after the user selects one of the menu items. Page 700 lists menu items 702, including a text field 704 for searching items on auction. Again, the user uses touch screen 308, joystick 311, or microphone 309 to move highlighted cursor 708 and to select one of the menu items. When highlighted cursor 708 is over text field 704, the user uses the keys in keypad 310 to capture typed letters, numbers, and words, or microphone 309 to capture spoken letters, numbers, and words. Subsequent pages can be similarly constructed as pages 600 and 700 to provide an easy interface for any user to navigate online service 226 using device 202.

FIG. 8 illustrates a screen 800 on display 308 of device 202 while accessing online service 226 that is an online search engine (e.g., Google) in one embodiment. In one embodiment, application software 409 is a mini-browser that displays a simplified website of online service 226. FIG. 8 illustrates a splash page 800 shown to the user when device 202 initially connects with online service 226. Page 800 lists menu items 802, including a text field 804 for the search terms. The user uses touch screen 308, joystick 311, or microphone 309 to move highlighted cursor 806 and to select one of the menu items. When highlighted cursor 806 is over text field 804, the user uses the keys in keypad 310 capture typed letters, numbers, and words, or microphone 309 to capture spoken letters, numbers, and words. Subsequent pages can be similarly constructed as page 800 to provide an easy interface for any user to navigate online service 226 using device 202.

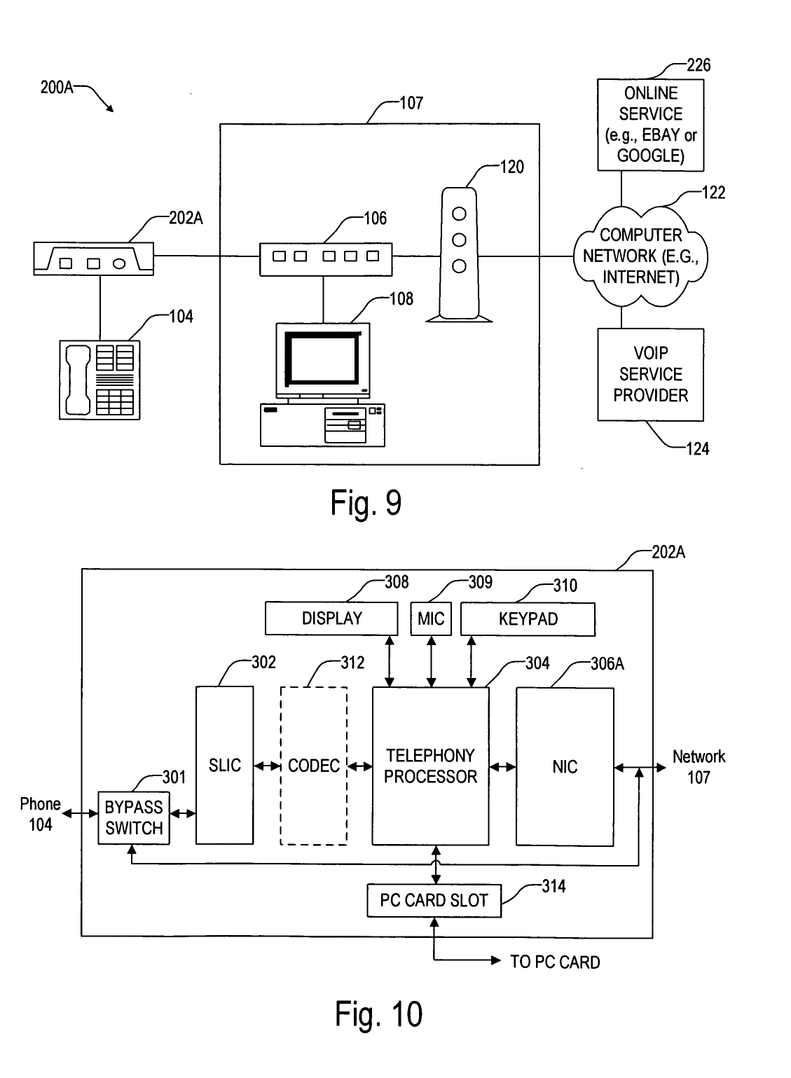

FIG. 9 illustrates a network telephone device 202A in a network telephone system 200A in one embodiment of the invention. Device 202A has a phone port connected to analog telephone 104 and a network port coupled to private computer network 107 with broadband access to public computer network 122 (e.g., the Internet). Device 202A can be coupled to router 106 or directly with broadband modem 108 in private computer network 107. Device 202A allows the user to use a broadband connection to make VoIP telephone calls and access online service 226.

FIG. 10 illustrates network telephone device 202A in one embodiment of the invention. Device 202A is essentially the same as device 202 in FIG. 3 but dial-up modem 306 has been replaced with a network interface card (NIC) 306A. NIC 306A may be an Ethernet card having a network port coupled to private computer network 107. Device 202A operates essentially in the same manner as device 202 except that NIC 306A routes the data packets to and from public computer network 122 through private computer network 107.

Various other adaptations and combinations of features of the embodiments disclosed are within the scope of the invention. Numerous embodiments are encompassed by the following claims.

What is claimed is:

1. A network telephone device, comprising:
a subscriber line/loop interface circuit (SLIC) for coupling to an analog telephone;
a memory storing a first software for Voice-over-Internet Protocol (VoIP) telephony and a second software for accessing an online service;
a telephony processor coupled to the SLIC and to the memory, the telephony processor converting outgoing telephone signals from the SLIC to outgoing data packets and converting incoming data packets into incoming telephone signals to the SLIC, the telephony processor executing at least one of the first and the second software in the memory; and
a network interface coupled to the telephony processor, the network interface converting the outgoing data packets from the telephony processor into outgoing signals, the network interface further converting incoming signals to the incoming data packets to the telephony processor.

2. The device of claim 1, wherein the online service is selected from the group consisting of eBay and Google.

3. The device of claim 1, wherein the second software is a mini-browser for accessing a website for the online service.

4. The device of claim 3, wherein the online service is selected from the group consisting of an online auction service and an online search engine.

5. The device of claim 4, further comprising a display coupled to the telephony processor for displaying the website for the online service.

6. The device of claim 5, wherein the display is a touch screen used to control the device

7. The device of claim 1, further comprising a keypad coupled to the telephony processor, wherein the keypad is used to control the device.

8. The device of claim 1, further comprising a microphone coupled to the telephony processor, wherein the memory further stores speech recognition software used to control the device.

9. The device of claim 1, further comprising the analog telephone.

10. The device of claim 1, wherein the network interface is selected from the group consisting of a narrowband modem and a broadband modem.

11. The device of claim 10, wherein the narrowband modem is a dial-up modem and the broadband modem is selected from the group consisting of a DSL modem and a cable modem.

12. The device of claim 1, further comprising a personal computer (PC) card interface coupled to the telephony processor.

13. The device of claim 12, further comprising a PC card received in the PC card interface, wherein the PC card is selected from the group consisting of a wireless PC card for communicating with a wireless computer network having broadband access to the Internet and a network adapter for communicating with a wired compute network having broadband access to the Internet.

14. A method for a network telephone device to provide VoIP telephone calls and access to an online service, comprising:
converting outgoing telephone signals from a SLIC to outgoing data packets and converting incoming data packets into incoming telephone signals to the SLIC;
transmitting the outgoing data packets and receiving the incoming data packets over a network connection; and
providing access to the online service over the network connection.

15. The method of claim 14, wherein the online service is selected from the group consisting of eBay and Google.

16. The method of claim 14, wherein said providing access to the online service comprises running a mini-browser for accessing a website for the online service.

17. The method of claim 16, wherein the online service is selected from the group consisting of an online auction service and an online search engine.

18. The method of claim 14, further comprising receiving touch screen inputs from a user to control the device.

19. The method of claim 14, further comprising receiving keypad inputs from a user to control the device.

20. The method of claim 14, further comprising receiving speech commands from a user to control the device.

21. The method of claim 20, wherein said providing access to the online service comprises accessing a webpage of the online service and the speech commands comprises a menu name on the webpage.

22. The method of claim 20, wherein said providing access to the online service comprises accessing a webpage of the online service and the speech commands comprises at least one of a letter, a number, and a word for a text field of the webpage.

23. The method of claim 14, wherein the network connection is selected from the group consisting of a narrowband connection and a broadband connection.

24. The method of claim 23, wherein the narrowband connection is a dial-up modem connection and the broadband connection is selected from the group consisting of a DSL modem connection and a cable modem connection.

25. The method of claim 14, wherein the network interface is selected from the group consisting of a wired broadband connection to the Internet and a wireless broadband connection to the Internet.
